(19) United States
(12) Patent Application Publication
(10) Pub. No.: US 2008/0210502 A1
(43) Pub. Date: Sep. 4, 2008

(54) PRESSURE MEDIUM BRAKE SYSTEM FOR A MOTOR VEHICLE AS WELL AS A MOTOR VEHICLE

(75) Inventor: Thomas GARBE, Affalterbach (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c.F. Porsche Aktiengesellschaft, Stuttgart (DE)

(21) Appl. No.: 12/038,323

(22) Filed: Feb. 27, 2008

(30) Foreign Application Priority Data
Mar. 2, 2007 (DE) 10 2007 010 199.8

(51) Int. Cl. B60T 8/24

(52) U.S. Cl. 188/192

(57) ABSTRACT

A pressure medium brake system for a motor vehicle such as a racing vehicle having at least one axle with two wheels and respectively assigned wheel brake cylinders includes devices for determining a cornering of the motor vehicle. A respective wheel brake cylinder of the axle can be controlled as a function of the curve.

### BACKGROUND AND SUMMARY OF THE INVENTION

This application claims the priority of German Patent Application No. 10 2007 010 199.8-21, filed Mar. 2, 2007, the disclosure of which is expressly incorporated by reference herein.

The present invention relates to a pressure medium brake system for a motor vehicle having one or more axles with two wheels and respective wheel brake cylinders assigned to the wheels as well as to a corresponding vehicle. In the following, a motor vehicle is a road vehicle which has, for example, a combustion, hybrid or electric drive, and the wheels may also be constructed as dual wheels.

The braking force that can be transferred from a wheel of a motor vehicle to the road depends mainly on the normal force experienced by this wheel. During cornering, the wheel of an axle that is on the inside during the cornering is relieved. As a result, the braking force of the axle is limited by this wheel because otherwise this wheel could lock and, for example, a braking flattening could occur. For improving the braking effect, technical systems are known which, by way of sensors assigned to the individual wheels, measure the respective slip at the wheel and ensure an improved braking effect by way of a corresponding control. For this purpose, corresponding sensors for each wheel and a high-expenditure electronic control are required. In this case, such antilock braking systems, however, mainly cause no shortening of the braking distance but principally have the effect that the motor vehicle remains steerable during the braking operation and does not swerve.

From DE 1 196 522, a braking force proportioning device is known for proportioning the braking force between the two axles of a motor vehicle as a function of its load. A balance beam system is used for this purpose in order to carry out a load-dependent adjustment by way of a hydraulic cylinder.

An object of the present invention is to provide a constructively relatively simple system which produces an increased braking effect at an axle without requiring a high-expenditure electronic control for this purpose.

This object has been achieved by providing devices for determining a cornering of the motor vehicle, in which case a respective wheel brake cylinder of an axle is controlled as a function of the curve. This causes a simple control of the brake load distribution for increasing the braking effect when cornering. It thereby now becomes possible to admit a higher braking pressure of the pressure medium brake system to the wheel of an axle that is on the outside during the cornering than to the wheel of the axle that is on the inside during the cornering, and to thus increase the braking force of the axle that can be transferred to the road. Particularly in the case of motor vehicles without an antilock system, such as racing vehicles, a reduction of the risk of wheel locking and thus of braking flattening takes place, and the lap time is positively influenced.

Preferably, the devices for determining the cornering of the motor vehicle are constructed as a function of the lateral acceleration. Since the normal force of a wheel depends on the lateral acceleration of the motor vehicle, this results in the simple possibility of determining the existence and the extent of a cornering of the motor vehicle.

A currently preferred embodiment of the invention provides a separate brake master cylinder for an individual wheel. The control of the wheel brake cylinders of an axle preferably includes a double-acting pressurized actuating cylinder that is coupled between the control rods for the wheel brake cylinders assigned to the respective wheels of the axle. In particular, the actuating cylinder tube is equipped with a joint in this case to which the actuation for the wheel brake cylinders of the axle is applied. This permits a constructively particularly simple implementation of the invention.

In the unloaded condition, that is, when driving straight ahead, the piston of the double-acting actuating cylinder is adjusted approximately in the center so that the brake application force is uniformly distributed between the respective wheel brake cylinders of axle. During a lateral acceleration, that is, during a cornering, a correspondingly different pressurization of the two actuating cylinder chambers is provided. The piston of the actuating cylinder is thereby displaced corresponding to the lateral acceleration, thus the intensity of the curve. A change of the lever arms between the respective wheel brake cylinders of the axle and the actuating cylinder therefore takes place.

Elements of a defined elasticity are preferably assigned to the actuating cylinder, for adjusting an approximate center position. As a result, when driving straight ahead, a central position, that is, a distribution of the braking force uniformly between the two wheel brake cylinders, is easily defined and maintained. Such elastic elements are, for example, gas, spring or plastic elements.

Particularly preferably, the pressurization of the double-acting cylinder is branched off the hydraulically supported steering wheel (power steering) booster. The differential chamber pressure of the power steering is proportional to the lateral acceleration and thus is very suitable for a cornering determination. Thus, the differential pressure occurring as a result of the steering forces during cornering can be used directly as a control variable for the brake load distribution to the wheel brake cylinders. Thus, no additional devices are required for operating the actuating cylinder.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic view of a preferred embodiment of the invention in the inoperative condition, i.e., when driving straight ahead; and

FIG. 2 is similar to FIG. 1 but shows the same embodiment during cornering, i.e., in the presence of a lateral acceleration.

### DETAILED DESCRIPTION OF THE DRAWINGS

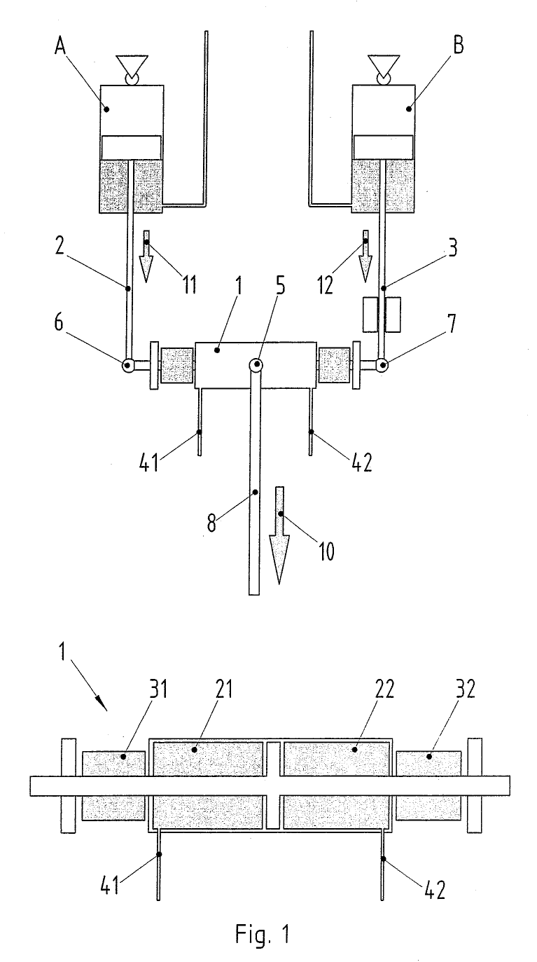

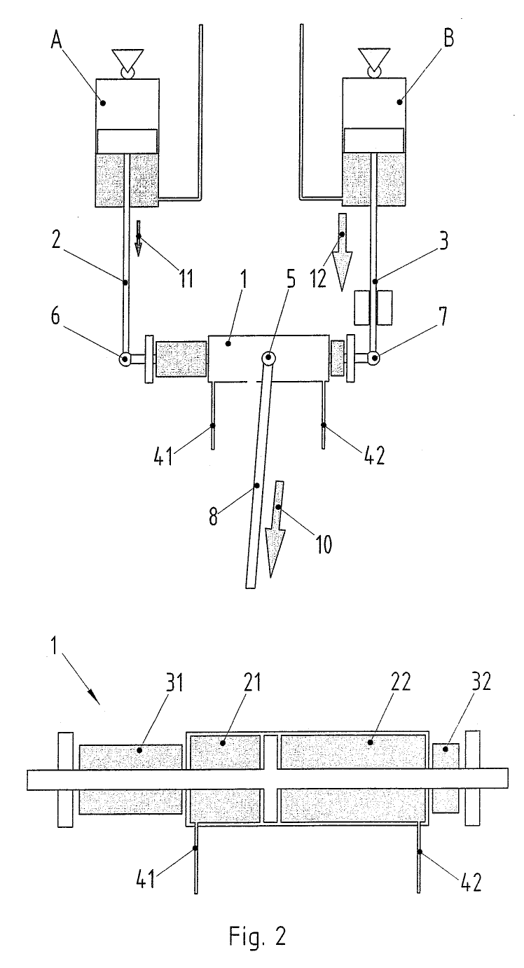

The same reference numbers are used for indicating the common elements of FIG. 1 and FIG. 2. FIG. 1 illustrates a double-acting pressurized actuating cylinder 1 that is arranged by joints 6, 7 between the operating rods 2, 3 for the respective wheel brake cylinders A, B of an axle of a motor vehicle. The actuating cylinder 1 is equipped with a joint 5 to which the actuation 8 for the wheel brake cylinders A, B is applied. When driving straight ahead as represented in FIG. 1, the brake application force illustrated by arrow 10 is uniformly distributed between the two wheel brake cylinders A, B as illustrated by arrows 11, 12 of the same length at the connections to the wheel brake cylinders A, B. By way of the respective supply pipes 41, 42, both actuating cylinder chambers 21, 22 are therefore filled approximately uniformly with a pressurized medium. The actuating cylinder 1 is then adjusted by elements of a defined elasticity 31, 32 in an approximate center position. The force application point is therefore in a position which distributes the brake application force approximately uniformly between the respective wheel brake cylinders A, B.

When a lateral acceleration occurs, i.e., during a cornering procedure, the piston of the double-acting actuating cylinders is displaced corresponding to the occurring lateral acceleration against the elements of a defined elasticity 31, 32. This is schematically illustrated in FIG. 2, in which the element 32 is shown in a compressed state. The pressurization of the two actuating cylinder chambers 21, 22 of the double-acting actuating cylinder 1 therefore differs corresponding to an occurring lateral acceleration when cornering, and this causes a change of the lever arms between the wheel brake cylinders A, B and the double-acting actuating cylinder 1. This change is illustrated by arrows 11, 12 of different sizes at the respective wheel brake cylinders A, B. The actuating cylinder tube has been displaced against the restoring force of the right-hand elastic element until an equilibrium of forces has occurred. As a result, the excursion of the actuating cylinder tube and therefore the force application point is proportional to the differential pressure of the actuating cylinder chambers 21, 22.

The origin of the supply pressure is the differential chamber pressure of the hydraulically supported steering power booster (power steering). This differential chamber pressure increases proportionately to the tie rod force and thus to the lateral acceleration of the vehicle. As a result, the differential pressure occurring because of the steering forces during a cornering can be used directly as a control variable for the brake load distribution. This control variable is therefore present as a directly usable quantity and therefore operates the actuating cylinder without influencing the reason for the actuating variable. The control can therefore be easily implemented without any high-expenditure controlling of the brake load distribution of the axle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Pressure medium brake system for a motor vehicle having at least one axle with two wheels and respectively assigned wheel brake cylinders, comprising apparatus configured to determine cornering of the motor vehicle when in a curve, and a respective wheel brake cylinder of the at least one axle is controlled as a function of the curve.

2. Pressure medium brake system according to claim 1, wherein the apparatus is configured to operate as a function of the lateral acceleration.

3. Pressure medium brake system according to claim 2, wherein a separate brake master cylinder is provided for an individual wheel.

4. Pressure medium brake system according to claim 3, wherein a double-acting pressurized actuating cylinder between the operating rods for the wheel brake cylinders assigned to the respective wheels is assigned to the at least one axle.

5. Pressure medium brake system according to claim 4, wherein the actuating cylinder has a joint to which the actuation for the two wheel brake

5. Pressure medium brake system according to claim 4, wherein the actuating cylinder has a joint to which the actuation for the two wheel brake cylinders of the axle is applied, namely an operating rod operatively associated with the brake pedal.

6. Pressure medium brake system according to claim 4, wherein elements of a defined elasticity are assigned to the actuating cylinder for adjustment of an approximate center position.

7. Pressure medium accordingly to claim 6, wherein elements of a defined elasticity are assigned to the actuating cylinder for adjustment of an approximate center position.

8. Pressure medium brake system according claim 4, wherein pressurization of the actuating cylinder is branched off an hydraulically supported steering power booster.

9. Pressure medium brake system according to claim 8, wherein the actuating cylinder has a joint to which the actuation for the two wheel brake cylinders of the axle is applied, namely an operating rod operatively associated with the brake pedal.

10. Pressure medium brake system according to claim 9, wherein elements of a defined elasticity are assigned to the actuating cylinder for adjustment of an approximate center position.

11. Motor vehicle, comprising a pressure medium braking system according to claim 1.

12. Motor vehicle according to claim 11, wherein the motor vehicle is racing vehicle.

13. Motor vehicle according to claim 11, wherein the vehicle excludes an antilock braking system.

14. Method for increasing a braking effect at an axle of a motor vehicle, comprising determining cornering of the motor vehicle when driving in a curve, and controlling a wheel brake cylinder of the axle as a function of the curve based upon a differential pressure of a steering system of the motor vehicle.
